(19) United States
(12) Patent Application Publication
(10) Pub. No.: US 2010/0162385 A1
(43) Pub. Date: Jun. 24, 2010

(54) Method of determining when a computer program password is under attack

(76) Inventor: Otto Melvin Wildensteiner, Hilton Head, SC (US)

Correspondence Address: Otto M. Wildensteiner, 5 Sanderling Lane, Hilton Head, SC, 29926, US

(21) Appl. No.: 12/314,935

(22) Filed: Dec. 19, 2008

(51) Int. Cl. H04L 9/32; G06F 21/00

(52) U.S. Cl. 726/18

(57) ABSTRACT

Determining the onset of a computer password attack by counting the total number of characters and the number of wrong characters in the submitted password and comparing these numbers to the correct password. If the total number of characters in the submitted password differs from the number in the correct password, or if the number of wrong characters exceeds the user-defined number allowed, a password attack is declared.

### BACKGROUND

Methods of determining that a computer password is under attack are well known in the art. However, they all suffer from the drawback that a substantial amount of time passes before the determination is made that an attack is under way. The more time that passes, the better the chance that the attacker will get lucky and submit the correct password.

Conversely, the sooner that an attack is determined to be under way the sooner it can be countered. However, compounding the problem is the fact that authorized users sometimes make mistakes in entering the password, so that merely determining that an attack is under way because the password that is entered is not exactly as required would result in many false alarms.

What is needed is a method of detecting a password attack that identifies the attack at the earliest possible time, preferably when the first password in the attack is received.

### OBJECTS OF THE INVENTION

Accordingly, it is an object of the present invention to provide a method of determining when a computer program is under attack with the submission of the first password in the attack.

It is a further object of the present invention to provide such method that will work with a password of any length.

It is a further object of the present invention to provide such method that allows legitimate users to make a selected number of typographical errors without causing a password attack alarm.

### SUMMARY

Briefly, the present invention comprises a method of determining that a password attack has been launched by examining the submitted password. If the total number of characters in the submitted password is not the same as the number of characters in the stored password, it obviously has come from a hacker since legitimate users know how many characters are in the password. Likewise, if the submitted password contains more than a user-defined maximum number of errors, it is also deemed the start of a password attack.

### BRIEF DESCRIPTION OF THE DRAWINGS

FIG. 1 is a flow diagram of the means and method of the present invention as part of an application program.

FIG. 2 is a flow diagram of the means and method of the present invention as part of the operating system of the computer on which the application is installed.

### DESCRIPTION OF THE PREFERRED EMBODIMENTS

Computer programs that contain sensitive material are protected by passwords that are stored in the program. In order to access the program a user has to submit the correct password, i.e. one that matches the password that is stored in the program. These passwords are usually random alpha-numeric strings, which makes it essentially impossible to just guess the password. Legitimate users are given the password so that they can use the program. Those who try to break into the program, called hackers, use sophisticated programs that can generate and submit all possible random character strings of whatever length desired; given enough time, these programs will come up with the correct password and allow entry into the program.

Currently there are methods of determining that a computer program password is under attack, but there is usually a lag between when the attack is started and when it is recognized as such. This gives the hacker a finite length of time or number of submitted passwords in which to get lucky and submit the correct password. The present invention reduces this time down to its absolute minimum.

All password-protected programs have software routines in them that compare the submitted password with the stored password. At present, these routines just determine whether or not all characters in the submitted password match those in the stored password; in short, this is a pass/fail test. In the present invention these routines are modified to incorporate the ability to count both the number of characters and the number of incorrect characters in the submitted password, and to base the determination that an attack is under way on these numbers.

The idea behind the present invention is that a legitimate user who is trying to access a program protected by a short password, for example 5 characters, will be able to type them in correctly or will proof-read his work and correct any mistakes. By contrast, a hacker will in all probability have at least one wrong character on his first try. Therefore in this instance a submitted password with one or more incorrect characters will be deemed to be the start of an attack, and countermeasures can be taken.

Likewise, if the program is protected by a 25 character password, a legitimate user could be granted the leeway of making for example 2 mistakes in his submitted password, since a hacker will in all probability have more than 2 wrong characters in a 25 character password on his first try. Thus in this instance 3 or more wrong characters in a submitted password would be deemed the start of an attack. The number of allowable wrong characters is set by the user when the program is installed in the computer, and obviously can be more or less than 2.

The start of a password attack can also be determined by just the number of characters in the submitted password. Legitimate users know how many characters are in the password, and any deviation from this number is deemed the start of a password attack, since the hacker usually doesn't know how many characters are in the password.

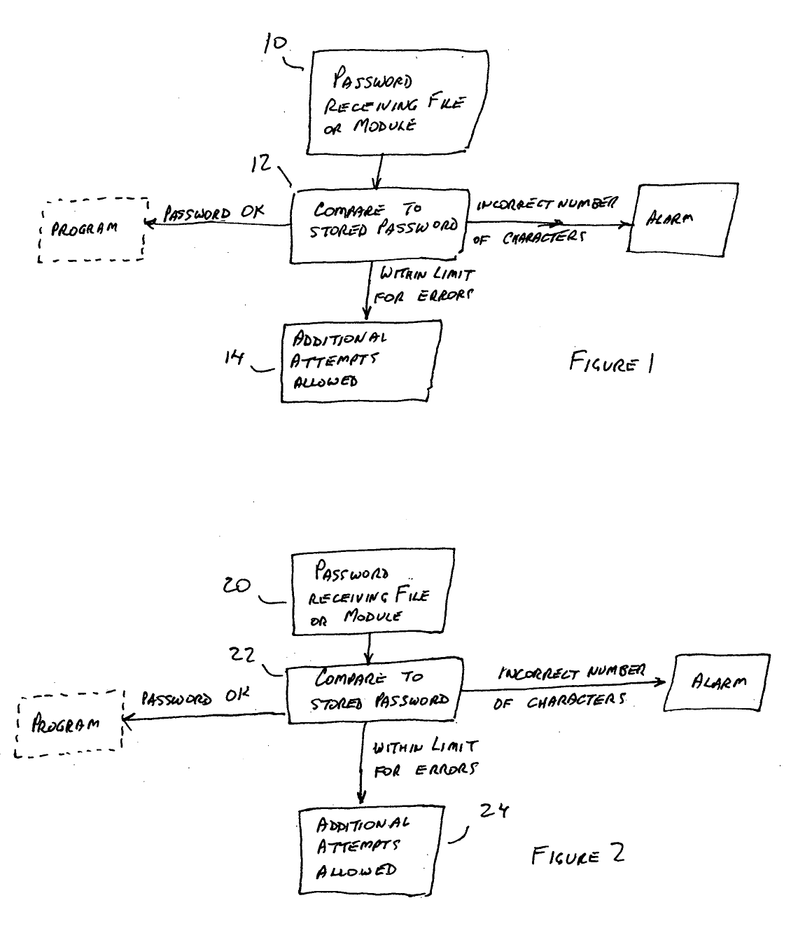

As shown in FIG. 1, a password is submitted by a would-be user to password-receiving file or module 10. It is then compared to the stored (or correct) password both for number of characters and number of wrong characters at file or module 12. If the number of characters differs from the number of characters in the stored password, this is deemed to be the start of a password attack and the alarm is raised. If the number of characters is correct, and the number of wrong characters is within the pre-set limit, file or module 14 allows additional attempts at submitting the correct password. If the submitted password matches the stored password, access is gained to the program.

As shown in FIG. 2, this can also be incorporated into the operating system of the computer. Submitted passwords are received in file or module 20 in a program and are then sent to file or module 22 in the operating system, which contains the passwords for all programs in the computer. Here they are compared to the correct password for that program for both number of characters and number of wrong characters, as above. If the number of characters differs from the number of characters in the stored password, this is deemed to be the start of a password attack and the alarm is raised. If the number of characters is correct, and the number of wrong characters is within the pre-set limit, file or module 24 in the program is directed to allow additional attempts at submitting the correct password. If the submitted password matches the stored password, access is gained to the program.

After it is determined that a password attack has been launched, any form of warning can be used; the computer can be programmed to make the sound of an alarm, a message could be printed on the screen, etc.

Using this method of counting the number of characters and the number of wrong characters in the submitted password will identify an attack usually with the first one that is submitted, rather than after a time lag as with prior art methods of identifying a password attack. The sooner an attack is determined to have started reduces the time that an attacker will have to generate the correct password.

I claim:

1. In a password-protected computer program, the method of determining the start of a password attack which comprises providing a password having a certain number of characters that is stored in said program, providing means for receiving a password that has been submitted in order to access said program, and providing means for comparing the total number of characters in said submitted password with the total number of characters in said stored password.

2. In a password-protected computer program, the method of determining the start of a password attack which comprises providing a password having a certain number of characters that is stored in said program, providing a maximum number of errors to be allowed in a submitted password, providing means for determining the number of errors in a submitted password, and providing means for comparing the number of errors in said submitted password with said maximum number of allowed errors.

3. In a computer, an operating system, a password-protected application program, and means in said operating system for storing said password.

4. A computer as in claim 3 wherein said operating system also contains means for receiving submitted passwords for said program and for comparing the number of characters in a submitted password with the number of characters in said stored password.

5. A computer as in claim 3 wherein said operating system also contains means for receiving submitted passwords for said program and for comparing the number of wrong characters in a submitted password with a user-defined maximum number of wrong characters.
